(19) United States
(12) Patent Application Publication
(10) Pub. No.: US 2020/0114419 A1
(43) Pub. Date: Apr. 16, 2020

(54) Cover For A Mold System And Mold System For A Cast-On Strap Process

(71) Applicant: East Penn Manufacturing Co., Lyon Station, PA (US)

(72) Inventor: Roland Hottenstein, JR., Kutztown, PA (US)

(73) Assignee: East Penn Manufacturing Co., Lyon Station, PA (US)

(21) Appl. No.: 16/158,811

(22) Filed: Oct. 12, 2018

(51) Int. Cl. B22D 25/04; B22D 35/04; B22D 39/02; H01M 2/30

(52) U.S. Cl. CPC B22D 25/04; B22D 35/04; B22D 19/04; H01M 2/302; B22D 39/02

(57) ABSTRACT

A cover for a mold system comprises a baseplate, a top plate fastened to the baseplate, and a strap tab disposed between the baseplate and the top plate. The baseplate extends in a longitudinal direction and has a base protrusion protruding beyond the baseplate in a width direction perpendicular to the longitudinal direction. The top plate extends in the longitudinal direction and has a top protrusion protruding beyond the top plate in the width direction. The strap tab is held between the base protrusion and the top protrusion in a height direction perpendicular to the longitudinal direction and the width direction and is movable along the base protrusion in the width direction.

### FIELD OF THE INVENTION

The present invention relates to a mold system and, more particularly, to a mold system used in a cast-on strap process for a lead-acid battery.

### BACKGROUND

A lead-acid battery has a plurality of cells connected in series to provide a desired battery voltage. Each cell includes a number of positive and negative plates, each plate having a tab extending from the plate. The plates are stacked in an alternating fashion with all tabs of a same polarity aligned. The positive and negative plates are connected by separate cast-on straps that are molded to the tabs of the plates. One of the straps connecting the positive plates is molded with a positive terminal post of the battery. One of the straps connecting the negative plates is molded with a negative terminal post of the battery.

To form the straps and terminal posts of the battery, it is known in the art to fill a mold system shown in FIG. 1 with molten lead and lower the tabs into the mold system. The mold system includes a mold 100′ having two mold sections 110′ and a pair of covers 200′ each attached to the mold 100′ at one of the mold sections 110′. The molten lead is pumped into a feed trough 120′ of each of the mold sections 110′. The lead then flows into a plurality of strap ducts 130′ extending from the feed trough 120′. Each of the strap ducts 130′ ends in a weir 140′ at an end opposite the feed trough 120′. The lead flows up in the feed trough 120′, filling a fill area of the feed trough 120′ and the strap duct 130′ up to the weir opening 142′ of the weir 140′ before spilling into a plurality of strap cavities 138′. The covers 200′ are positioned to restrict a portion of the volume of the feed trough 120′ of each mold section 110′, as the volume of the fill area is directly related to the time required to operate the pump to fill the strap cavities 138′.

Pumping of the molten lead is stopped when the molten lead fills the strap cavities 138′. When the lead pump ceases, the molten lead at the strap duct 130′ and feed trough 120′ recedes; molten lead positioned at the weirs 140′ flows back into the strap duct 130′ when pumping of the molten lead ceases. The tabs of the battery plates are inserted in the strap cavities 138′ and the displaced lead flows back into strap duct 130′. Molten lead is then cooled and solidified to form the intermediate straps and terminal posts of the battery.

Over repeated uses of the mold system, some of the lead exposed in the strap ducts 130′ cools to form a particulate dross coating the strap ducts 130′. This dross can travel into the strap cavities 138′ in subsequent fills, impairing a quality of the formed straps and terminal posts. The exposure and shape of the strap ducts 130′ and the weirs 140′ also forms a large flash of excess lead on each of the cast straps and terminals. The large flash increases a quantity of lead used in each battery, and as lead is an expensive material, notably increases a manufacturing cost of each battery. Additionally, a quantity of molten lead is pumped into each strap cavity 138′ in the mold system of FIG. 1; it is not possible to adjust an amount of molten lead that enters different strap cavities 138′.

### SUMMARY

A cover for a mold system comprises a baseplate, a top plate fastened to the baseplate, and a strap tab disposed between the baseplate and the top plate. The baseplate extends in a longitudinal direction and has a base protrusion protruding beyond the baseplate in a width direction perpendicular to the longitudinal direction. The top plate extends in the longitudinal direction and has a top protrusion protruding beyond the top plate in the width direction. The strap tab is held between the base protrusion and the top protrusion in a height direction perpendicular to the longitudinal direction and the width direction and is movable along the base protrusion in the width direction.

### BRIEF DESCRIPTION OF THE DRAWINGS

The invention will now be described by way of example with reference to the accompanying Figures, of which:

FIG. 1 is a perspective view of a mold system according to the prior art;

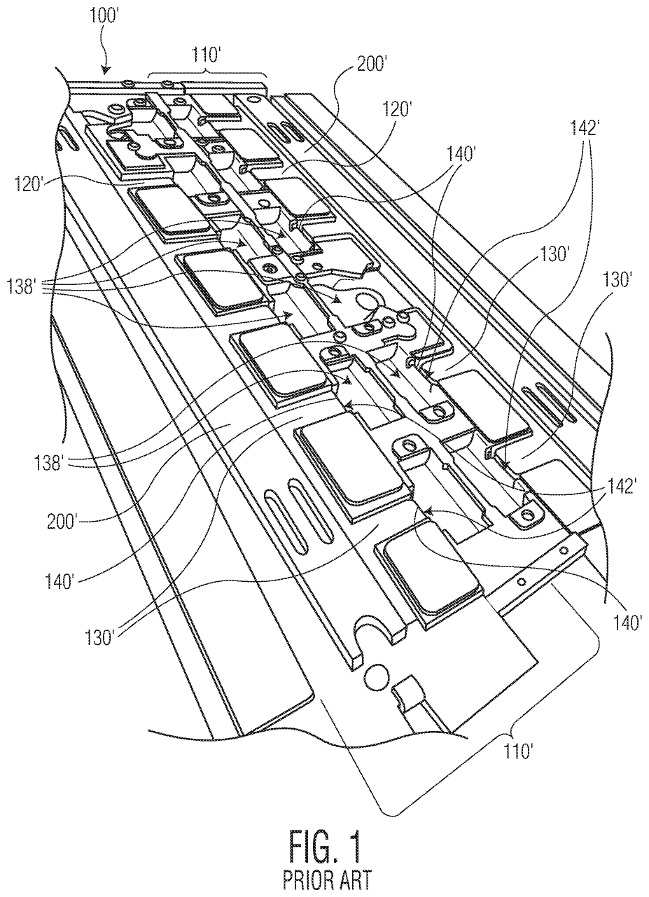

FIG. 2 is a perspective view of a mold system according to an embodiment of the invention;

FIG. 3 is a top view of a mold of the mold system of FIG. 2;

FIG. 4 is a perspective view of a cover of the mold system of FIG. 2;

FIG. 5 is an exploded perspective view of the cover of FIG. 4;

FIG. 6 is a sectional side view of the mold system of FIG. 2;

FIG. 7 is a sectional side view of the mold system of FIG. 2; and

FIG. 8 is a perspective view of a battery produced with the mold system of FIG. 2.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

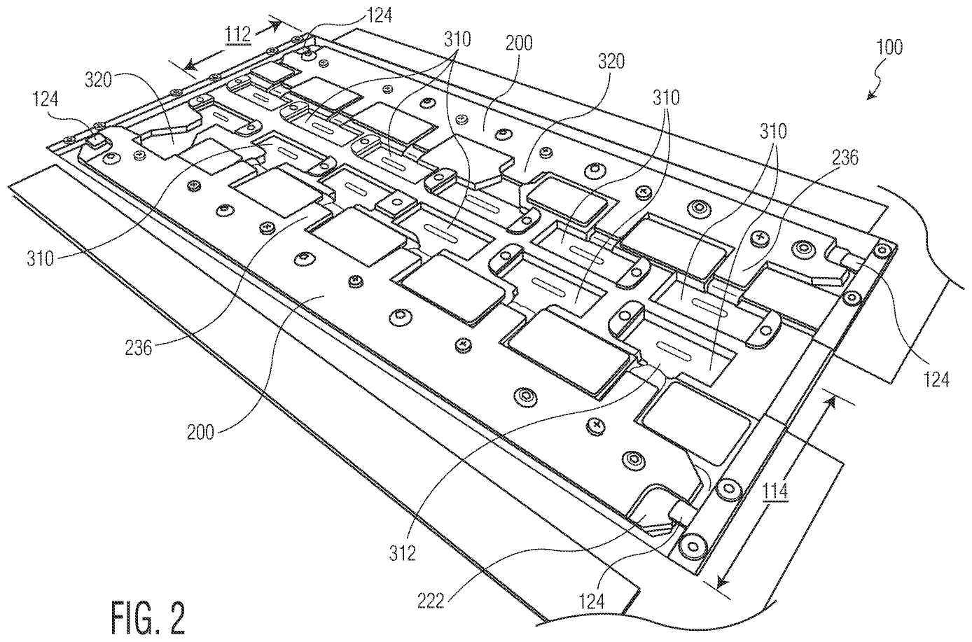

A mold system according to an embodiment of the invention is shown in FIG. 2. The mold system includes a mold 100 and a pair of covers 200 attached to the mold 100. The mold system is used in a cast-on strap process for a lead-acid battery, as is described in greater detail below.

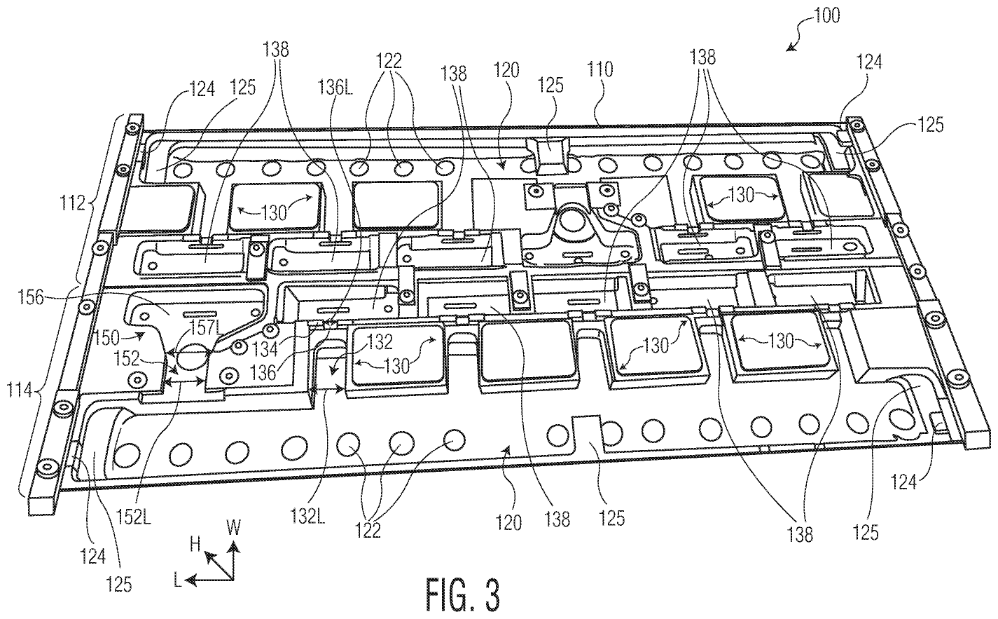

The mold 100, as shown in FIGS. 2 and 3, includes a mold body 110 with a first mold section 112 and a second mold section 114. Each of the mold sections 112, 114 forms a half of the mold 100 and each is used to mold a plurality of straps and a terminal on one side of the battery. In an embodiment, one of the mold sections 112, 114 is used to mold the straps and the terminal on the positive side of the battery, and the other of the mold sections 112, 114 is used to mold the straps and the terminal on the negative side of the battery. In other embodiments, each of the mold sections 112, 114 may be used to mold straps and a terminal of different polarity. Each of the mold sections 112, 114 includes the same structural elements, however, the elements may be arranged differently between the two mold sections 112, 114 as described in greater detail below.

As shown in FIG. 3, each of the mold sections 112, 114 includes a feed trough 120, a plurality of strap molds 130 extending from the feed trough 120, and a terminal mold 150 extending from the feed trough 120.

The feed trough 120, as shown FIG. 3, is formed in the mold body 110 and extends along a longitudinal direction L—of the mold section 112, 114 between opposite ends of the mold section 112, 114. The feed trough 120 includes a plurality of lead passageways 122 extending through the feed trough 120 in a height direction H perpendicular to the longitudinal direction L, a plurality of supports 125 higher than the feed trough 120 in the height direction H and distributed along the feed trough 120 along the longitudinal direction L, and a pair of cover securing members 124 disposed on opposite ends of the feed trough 120 in the longitudinal direction L. In the embodiment shown in FIGS. 2 and 3, the cover securing members 124 are flat tabs that are movable along the longitudinal direction L into and out of a position overlapping with at least some of the supports 125 of the feed trough 120.

The strap molds 130, as shown in FIG. 3, each include a strap duct 132 extending from the feed trough 120, a weir 134 disposed at the end of the strap duct 132, and a strap cavity 138 disposed on a side of the weir 134 opposite the strap duct 132.

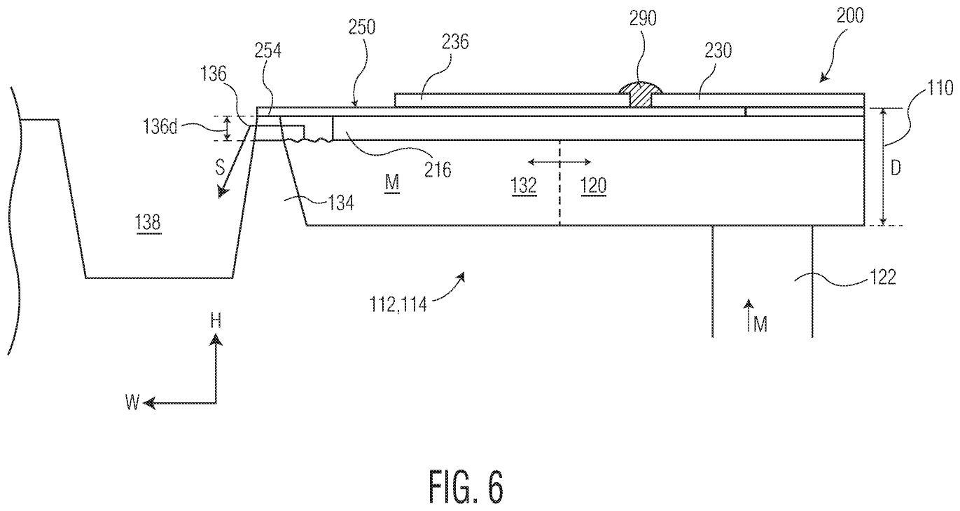

The strap duct 132 is formed in the mold body 110 to a same depth D in the height direction H as the feed trough 120, as shown in FIGS. 3 and 6. The strap duct 132 communicates with the feed trough 120 and extends from the feed trough 120 in a width direction W perpendicular to the longitudinal direction L.

The weir 134 is disposed between the strap duct 132 and the strap cavity 138 in the width direction W and forms a barrier extending in the height direction H between the strap duct 132 and the strap cavity 138. As shown in FIGS. 3 and 6, the weir 134 has a weir opening 136 disposed at a top of the weir 134 in the height direction H. The weir opening 136 extends into the mold body 110 in the height direction H to a depth 136d that is less than the depth D of the strap duct 132 and the feed trough 120. In the embodiment shown in FIG. 3, the weir opening 136 has a length 1361 in the longitudinal direction L that is less than a length 1321 of the strap duct 132 in the longitudinal direction L. In another embodiment, the length 1361 of the weir opening 136 may be equal to the length 1321 of the strap duct 132.

The strap cavity 138 is dimensioned to form straps particular to various battery applications. The strap cavity 138 has a depth in the height direction H that is greater than the depth 136d of the weir opening 136. In the embodiment shown in FIG. 6, the strap cavity 138 has a depth in the height direction H that is greater than the depth D of the strap duct 132 and the feed trough 120. In other embodiments, the strap cavity may have other depths in the height direction H relative to the strap duct 132 and the feed trough 120.

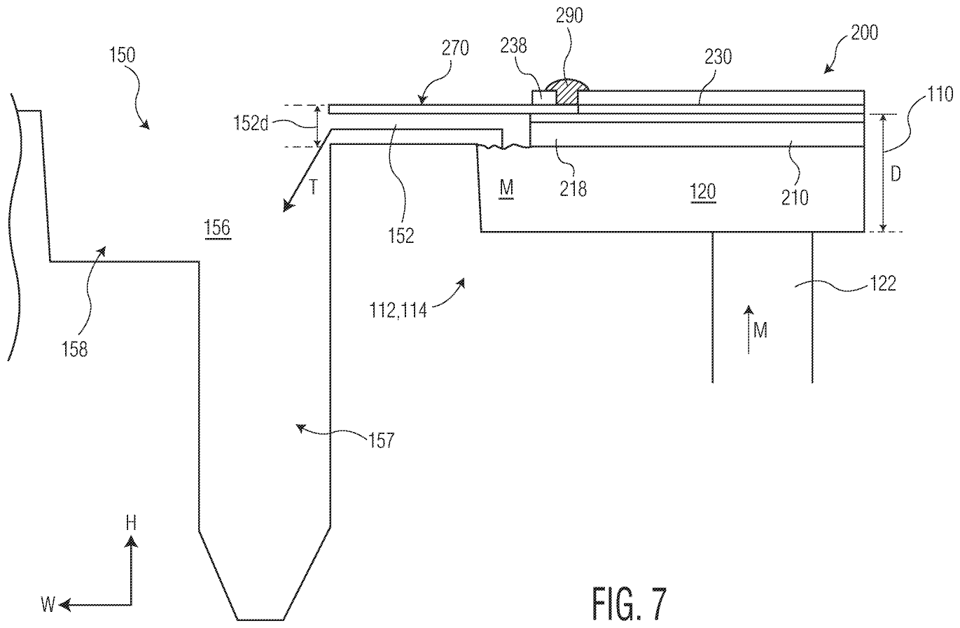

The terminal mold 150, as shown in FIGS. 3 and 7, includes a terminal channel 152 extending from the feed trough 120 and a terminal cavity 156 disposed at an end of the terminal channel 152 opposite the feed trough 120.

The terminal channel 152 extends into the mold body 110 in the height direction H to a depth 152d that is less than the depth D of the feed trough 120, as shown in FIG. 7. In the embodiment shown in FIG. 3, the terminal channel 152 has a length 1521 in the longitudinal direction L that is constant along the width direction W and is approximately equal to a length 1571 of a post portion 157 of the terminal cavity 156 in the longitudinal direction L. In other embodiments, the length 1521 may vary over the width direction W; the terminal channel 152 may have a funnel shape.

The terminal cavity 156 includes the post portion 157 and a strap portion 158, as shown in FIG. 7, and is dimensioned to integrally form a strap and a terminal post particular to various battery applications. The terminal cavity 156 has a depth in the height direction H that is greater than the depth 152d of the terminal channel 152. In the embodiment shown in FIG. 7, the post portion 157 of the terminal cavity 156 extends to a greater depth in the height direction H than the strap portion 158 of the terminal cavity 156.

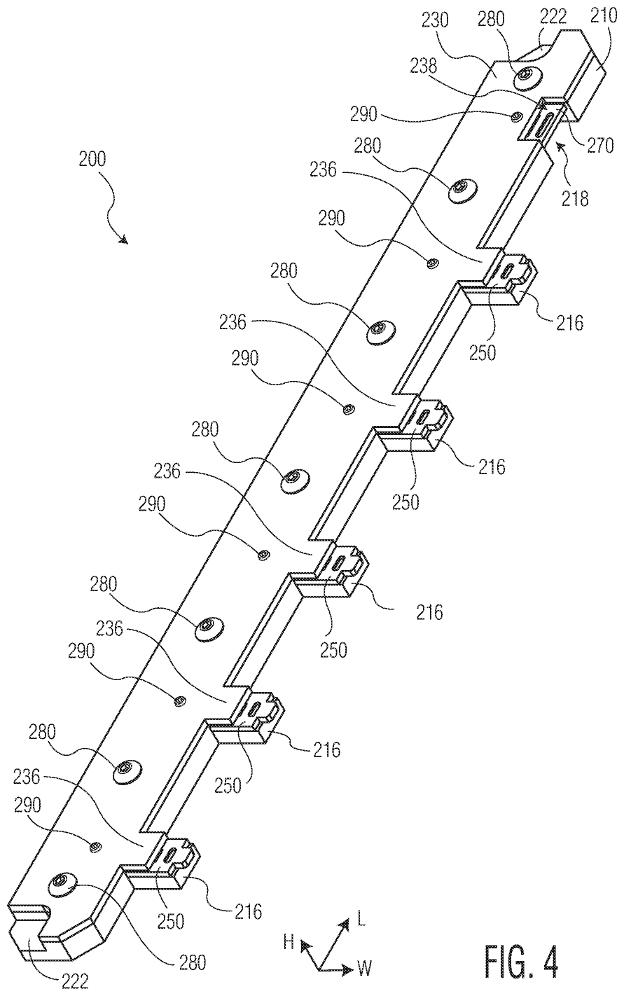

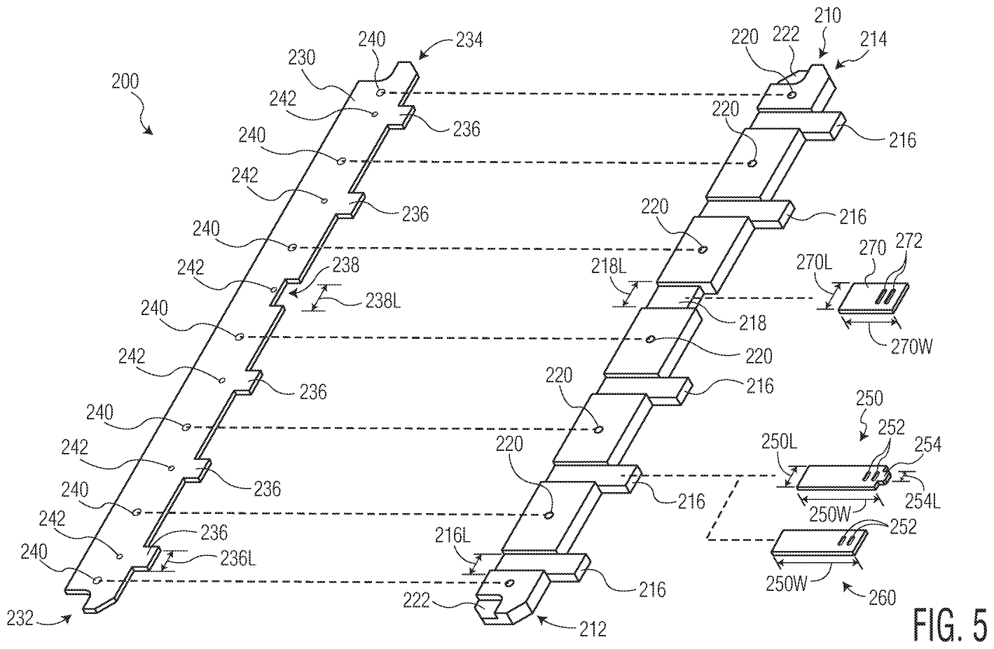

The cover 200, as shown in FIGS. 4 and 5, includes a baseplate 210, a top plate 230 secured to the baseplate 210, and a plurality of strap tabs 250 and a terminal tab 270 disposed between the baseplate 210 and the top plate 230.

The baseplate 210, as shown in FIGS. 4 and 5, extends in the longitudinal direction L from a first end 212 to a second end 214. The baseplate 210 is integrally formed in a single piece. In an embodiment, the baseplate 210 is formed from a metal material. In other embodiments, the baseplate 210 may be integrally formed from any material capable of withstanding a temperature of molten lead.

The baseplate 210 includes a plurality of base protrusions 216 and a recessed base portion 218 distributed evenly along the baseplate 210 between the first end 212 and the second end 214. As shown in FIG. 5, the base protrusions 216 each protrude beyond the baseplate 210 in the width direction W. The recessed base portion 218 is smaller than the baseplate 210 in the width direction W. Both the base protrusions 216 and the recessed base portion 218 are shorter than the baseplate 210 in the height direction H. In other embodiments, the width of the recessed base portion 218 and the width of the base protrusions 216 may vary over the width direction W.

The baseplate 210, as shown in FIG. 5, includes a plurality of fastener receiving passageways 220 extending into the baseplate 210 in the height direction H and distributed evenly along the baseplate 210 between the first end 212 and the second end 214. In an embodiment, the fastener receiving passageways 220 are threaded. The baseplate 210 has a securing recess 222 disposed at each of the first end 212 and the second end 214.

The top plate 230, as shown in FIGS. 4 and 5, extends in the longitudinal direction L from a first end 232 to a second end 234. The top plate 230 is integrally formed in a single piece and has a plate-like shape; the top plate 230 has a constant height in the height direction H between the first end 232 and the second end 234. In an embodiment, the top plate 230 is formed from a metal material. In other embodiments, the top plate 230 may be integrally formed from any material capable of withstanding a temperature of molten lead.

As shown in FIGS. 4 and 5, the top plate 230 includes a plurality of top protrusions 236 and a recessed top portion 238 distributed evenly along the top plate 230 between the first end 232 and the second end 234. As shown in FIG. 5, the top protrusions 236 each protrude beyond the top plate 230 in the width direction W and the recessed top portion 238 is smaller than the top plate 230 in the width direction W. In the shown embodiment, the top protrusions 236 protrude beyond the top plate 230 to a shorter length than the base protrusions 216 protrude beyond the baseplate 210 in the width direction W. In the shown embodiment, the recessed top portion 238 has a same smaller dimension than the top plate 230 in the width direction W as the recessed base portion 218 in the baseplate 210.

The top plate 230, as shown in FIG. 5, includes a plurality of fastener receiving passageways 240 and a plurality of tab securing member passageways 242 extending through the top plate 230 in the height direction H and distributed evenly along the top plate 230 between the first end 232 and the second end 234. The tab securing member passageways 242 are each aligned with one of the top protrusions 236 and the recessed top portion 238 along the width direction W. In an embodiment, the fastener receiving passageways 240 and the tab securing member passageways 242 are threaded.

Each of the plurality of strap tabs 250, as shown in FIGS. 4 and 5, is an approximately rectangular plate-like member. Each of the strap tabs 250 has a plurality of indentations 252 extending into a top surface of the strap tab 250. In the embodiment shown in FIGS. 4 and 5, each strap tab 250 has a weir tip 254 protruding from an end of the strap tab 250 in the width direction W. The weir tip 254 is disposed approximately centrally on the end of the strap tab 250 and is smaller than the strap tab 250 in the longitudinal direction L. In another embodiment, shown in FIG. 5, a strap tab 260 does not have the weir tip 254 but is otherwise identical to the strap tab 250. The strap tabs 250, 260 are capable of being used interchangeably in the cover 200. Each of the strap tabs 250, 260 is integrally formed in a single piece. In an embodiment, the strap tabs 250, 260 are formed from a metal material. In other embodiments, the strap tabs 250, 260 may be integrally formed from any material capable of withstanding a temperature of molten lead.

The terminal tab 270, as shown in FIGS. 4 and 5, is an approximately rectangular plate-like member. The terminal tab 270 has a plurality of indentations 272 extending into a top surface of the terminal tab 270. In the shown embodiment, the terminal tab 270 has a width 270w that is smaller than a width 250w of the strap tab 250 in the width direction W, and has a length 2701 that is larger than a length 2501 of the strap tab 250 in the longitudinal direction L. The terminal tab 270 is integrally formed in a single piece. In an embodiment, the terminal tab 270 is formed from a metal material. In other embodiments, the terminal tab 270 may be integrally formed from any material capable of withstanding a temperature of molten lead.

In the embodiment shown in FIGS. 3-5, a length 2501 of the strap tab 250 is approximately equal to a length 2161 of each of the base protrusions 216, equal to a length 2361 of each of the top protrusions 236, and equal to the length 1321 of each of the strap ducts 132 in the longitudinal direction L. A length 2541 of the weir tip 254 in the longitudinal direction L is equal to the length 1361 of each of the weir openings 136. Likewise, the length 2701 of the terminal tab 270 is approximately equal to a length 2181 of the recessed base portion 218, equal to a length 2381 of the recessed top portion 238, and equal to a length 1521 of the terminal channel 152.

The assembly of each cover 200 will now be described in greater detail with reference to FIGS. 4 and 5. The top plate 230 is positioned on the baseplate 210 with the plurality of top protrusions 236 aligned with the plurality of base protrusions 216, the recessed top portion 238 aligned with the recessed base portion 218, and the plurality of fastener receiving passageways 240 aligned with the plurality of fastener receiving passageways 220. The strap tabs 250 are each positioned on one of the base protrusions 216 and held between the base protrusion 216 and the top protrusion 236 in the height direction H. Only one of the strap tabs 250 is shown in FIG. 5 for simplicity in the drawings but, as shown in FIG. 4, one of the strap tabs 250 is disposed between each base protrusion 216 and top protrusion 236. The terminal tab 270 is positioned on the recessed base portion 218 and held between the recessed base portion 218 and the recessed top portion 238.

A plurality of fasteners 280, as shown in FIG. 4, are positioned in the plurality of fastener receiving passageways 240 and extend into the plurality of fastener receiving passageways 220 to fasten the top plate 230 to the baseplate 210. In the shown embodiment, the fasteners 280 are screws. In other embodiments, the fasteners 280 may be any type of fastener capable of securing the top plate 230 to the bottom plate 210. When the top plate 230 is fastened to the baseplate 210, the strap tabs 250 and the terminal tab 270 are held between the top plate 230 and the baseplate 210 in the height direction H but are movable along the base protrusions 216 or the recessed base portion 218, respectively, in the width direction W.

As shown in FIG. 4, a plurality of tab securing members 290 are positioned in the plurality of tab securing member passageways 242. Each of the tab securing members 290 is movable in the tab securing member passageway 242 between a release position and a locked position. In the release position, the strap tab 250 or the terminal tab 270 is free to move in the width direction W. In the locked position, the tab securing member 290 engages the top surface of the strap tab 250 or the terminal tab 270, preventing movement of the strap tab 250 or the terminal tab 270 in the width direction W. In the shown embodiment, the tab securing members 290 are screws. In other embodiments, the tab securing members 290 may be any member capable of moving into and out of engagement with the strap tabs 250 and the terminal tab 270.

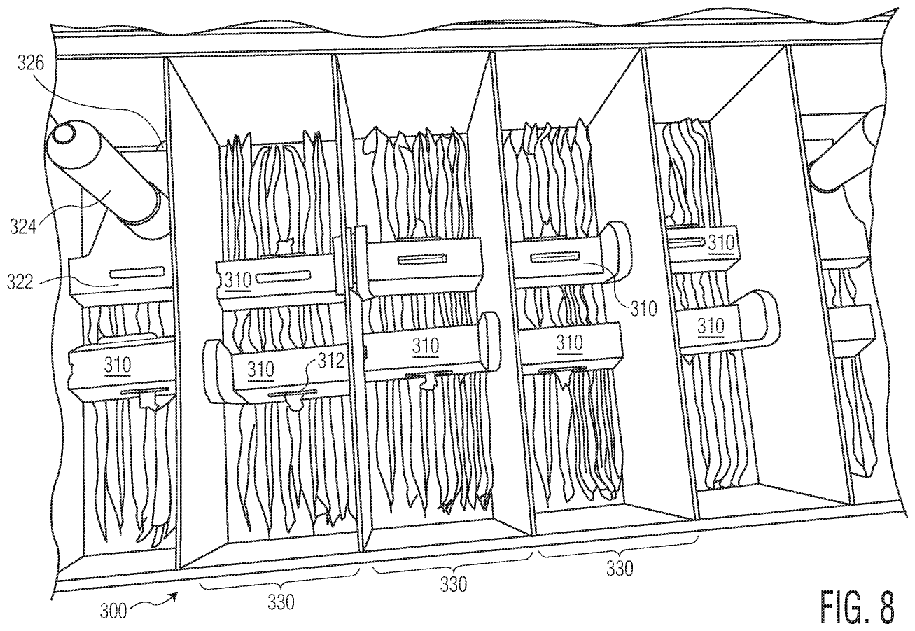

The use of the mold system to mold a plurality of straps 310 and a plurality of terminals 320 of a lead-acid battery 300, shown in FIGS. 2 and 8, will now be described primarily with reference to FIGS. 6 and 7.

The covers 200, as shown in FIG. 2, are each attached to the mold 100 with one of the covers 200 attached to the first mold section 112 and another cover 200 attached to the second mold section 114. The baseplate 210 and the top plate 230 are positioned in the feed trough 120; the baseplate 210 abuts the supports 125 and the cover securing members 124 are moved to engage the securing recesses 222 of the baseplate 210 to removably secure the baseplate 210 in the feed trough 120 at a distance from the bottom of the feed trough 120 in the height direction H, as shown in FIGS. 6 and 7.

As shown in FIG. 2, the base protrusions 216, the top protrusions 236, and the strap tabs 250 correspond to the strap mold 130 and extend into the strap ducts 132. The recessed base portion 218, the recessed top portion 238, and the terminal tab 270 correspond to the terminal mold 150 and are positioned in alignment with the terminal channel 152.

As shown in FIG. 2, the position of the terminal mold 150 with respect to the strap mold 130 along the longitudinal direction L can be different in various battery applications and can be different between the first mold section 112 and the second mold section 114. Correspondingly, the position of the recessed portions 218, 238 and the terminal tab 270 with respect to the protrusions 216, 236 and the strap tabs 250 along the longitudinal direction L of the covers 200 varies for different applications. The position of these elements in the shown embodiment is merely exemplary. In all embodiments, however, the base protrusions 216, the top protrusions 236, and the strap tabs 250 are positioned to correspond to the strap mold 130 and the recessed base portion 218, the recessed top portion 238, and the terminal tab 270 are positioned to correspond to the terminal mold 150.

As shown in FIGS. 6 and 7, the tab securing members 290 are moved into the release position and an operator manually moves the strap tabs 250 in the width direction W up to the weir 134 and moves the terminal tab 270 over the terminal channel 152. The strap tabs 250 are moved up to a position in which the strap tab 250 overlaps the strap duct 132 in the height direction H and the weir tip 254 entirely overlaps the weir opening 136 in the height direction H. The terminal tab 270 is moved up to a position in which the terminal tab 270 entirely overlaps the terminal channel 152 in the height direction H. The tab securing members 290 are then moved into the locked position when the strap tabs 250 and the terminal tab 270 are positioned appropriately for the particular mold 100. The manual positioning of the strap tabs 250 and the terminal tab 270 accommodates molds of different size and ensures that the strap ducts 132 and the terminal channel 152 are covered in various sized applications. The indentations 252, 272 permit the operator to easily move the strap tabs 250 and the terminal tab 270.

When the covers 200 are secured to the first mold section 112 and the second mold section 114, and the strap tabs 250 and the terminal tab 270 are positioned as described above, a pump (not shown) is operated to pump a molten lead M through the lead passageways 122 and into the feed trough 120, as shown in FIGS. 6 and 7. The molten lead M is pumped into the feed trough 120 until a level of the lead M fills a space up to a bottom of the baseplate 210. The pump is operated to maintain this level of the lead M between battery castings.

To cast the straps 310 of the battery 300, as shown in FIG. 6, the pump continues to pump molten lead M into the feed trough 120 and the molten lead M moves along a strap path S under the strap tab 250 and the weir tip 254, through the weir opening 136, and into the strap cavity 138. The top protrusions 236 prevent movement of the strap tab 250 due to a force of the molten lead M on the strap tab 250. The pump continues to operate until the strap cavity 138 is filled to a desired depth.

To cast the terminals 320 of the battery 300 simultaneously with the straps 310, as shown in FIG. 7, when the pump continues to pump molten lead M into the feed trough 120, the molten lead moves along a terminal path T between the terminal tab 270 and the terminal channel 152 and into the terminal cavity 156. The pump continues to operate until the terminal cavity 156 is filled to a desired depth.

When the strap cavities 138 and the terminal cavity 156 are filled to the desired depths, the pump speed is changed and the molten lead M returns to the level up to the bottom of the baseplate 210 shown in FIGS. 6 and 7. The pump operates to maintain the molten lead M at this level between fills of the strap cavities 138 and the terminal cavity 156.

With the strap cavities 138 and the terminal cavity 156 filled with the molten lead M, the battery 300 is inverted and a tab of each of a plurality of cells 330 of the battery 300 is inserted into the molten lead M. The lead M is then cooled and the battery 300 is removed from the mold system with the straps 310 and terminals 320 cast on the cells 330 as shown in FIG. 8. The lead M in each of the strap cavities 138 forms the straps 310. The lead M in the post portion 157 of the terminal cavity 156 forms a post portion 324 of the terminal 320 and the lead M in the strap portion 158 or the terminal cavity 156 forms the strap portion 322 of the terminal 320.

As a result of the cast-on strap process using the mold system, the straps 310 each have a flash 312 and the terminals 320 each have a flash 326 as shown in FIG. 8. However, due to the tabs 250, 270, other elements of the covers 200, the weir openings 136, and the terminal channels 152, the size of the flash 312, 326 is minimized or eliminated. Each strap 310 and terminal 320 therefore requires less lead, leading to a decrease in cost of producing the battery 300. The mold 100 and covers 200 as described herein also permit the pump to maintain a high level of molten lead M between castings and shorten a path to fill the strap cavities 138 and terminal cavity 156, lessening a time required to fill the strap cavities 138 and terminal cavity 156 to cast a battery 300. The covers 200 are adjustable to cover the strap ducts 132 and terminal channel 152 for various sized molds 100, preventing the formation of dross between castings and reducing strap thickness variation from cell to cell.

What is claimed is:

1. A cover for a mold system, comprising:
a baseplate extending in a longitudinal direction and having a base protrusion protruding beyond the baseplate in a width direction perpendicular to the longitudinal direction;
a top plate extending in the longitudinal direction and fastened to the baseplate, the top plate having a top protrusion protruding beyond the top plate in the width direction; and
a strap tab disposed between the baseplate and the top plate, the strap tab held between the base protrusion and the top protrusion in a height direction perpendicular to the longitudinal direction and the width direction and movable along the base protrusion in the width direction.

2. The cover of claim 1, wherein the baseplate has a recessed base portion smaller than the baseplate in the width direction and the top plate has a recessed top portion smaller than the top plate in the width direction, the recessed top portion aligned with the recessed base portion in the height direction.

3. The cover of claim 2, further comprising a terminal tab disposed between the baseplate and the top plate, the terminal tab held between the recessed base portion and the recessed top portion in the height direction and movable along the recessed base portion in the width direction.

4. The cover of claim 3, wherein the terminal tab has a width that is smaller than a width of the strap tab in the width direction and has a length that is larger than a length of the strap tab in the longitudinal direction.

5. The cover of claim 1, further comprising a tab securing member extending through the top plate and movable into and out of engagement with the strap tab.

6. The cover of claim 5, wherein the tab securing member is movable between a release position in which the strap tab is free to move in the width direction and a locked position in which the tab securing member engages the strap tab and prevents movement of the strap tab in the width direction.

7. The cover of claim 1, wherein the base protrusion extends further from the baseplate in the width direction than the top protrusion extends from the top plate in the width direction.

8. The cover of claim 1, wherein the strap tab has a weir tip protruding from an end of the strap tab in the width direction, the weir tip is disposed approximately centrally on the end of the strap tab and is smaller than the strap tab in the longitudinal direction.

9. The cover of claim 1, wherein the strap tab has an indentation extending into a top surface of the strap tab.

10. The cover of claim 3, wherein the baseplate has a plurality of base protrusions protruding beyond the baseplate in the width direction and the top plate has a plurality of top protrusions protruding beyond the top plate in the width direction, each of the top protrusions is aligned with one of the base protrusions in the height direction.

11. The cover of claim 10, further comprising a plurality of strap tabs, each of the strap tabs is held between one of the top protrusions and one of the base protrusions in the height direction and is movable along the one of the base protrusions in the width direction.

12. The cover of claim 10, wherein the baseplate and the top plate are each integrally formed in a single piece.

13. The cover of claim 12, wherein the top plate has a constant height in the height direction between a first end of the top plate and a second end of the top plate opposite the first end in the longitudinal direction.

14. The cover of claim 13, wherein the base protrusions and the recessed base portion each have a shorter height than the baseplate in the height direction.

15. The cover of claim 1, wherein the baseplate has a securing recess disposed at each of a first end of the baseplate and a second end of the baseplate opposite the first end in the longitudinal direction.

16. A mold section for a mold of a mold system, comprising:
a feed trough having a plurality of lead passageways through which a molten lead can be moved into the feed trough; and
a strap mold having:
a strap duct extending from the feed trough;
a weir disposed at an end of the strap duct opposite the feed trough and having a weir opening disposed at a top of the weir in a height direction; and
a strap cavity disposed on a side of the weir opposite the strap duct, the weir forms a barrier in the height direction between the strap duct and the strap cavity, the weir opening has a depth in the height direction that is less than a depth of the strap duct in the height direction and has a length in a longitudinal direction perpendicular to the height direction that is less than a length of the strap duct in the longitudinal direction.

17. The mold section of claim 16, wherein the strap duct has at least a same depth in the height direction as the feed trough.

18. The mold section of claim 16, wherein the feed trough has a cover securing member disposed at each of a pair of opposite ends of the feed trough in the longitudinal direction.

19. The mold section of claim 16, further comprising a terminal mold having a terminal channel extending from the feed trough and a terminal cavity disposed at an end of the terminal channel opposite the feed trough.

20. The mold section of claim 19, wherein the terminal channel has a depth in the height direction that is less than a depth of the feed trough in the height direction and has a length in the longitudinal direction that is constant along a width direction perpendicular to the height direction and the longitudinal direction.

21. The mold section of claim 19, wherein the terminal cavity includes a post portion adapted to mold a terminal post of a battery and a strap portion adapted to integrally mold a strap of the battery with the terminal post.

22. A mold system, comprising:
a mold including a mold section having:
a feed trough having a plurality of lead passageways through which a molten lead can be moved into the feed trough; and
a strap mold having a strap duct extending from the feed trough, a weir disposed at an end of the strap duct opposite the feed trough and having a weir opening disposed at a top of the weir in a height direction, and a strap cavity disposed on a side of the weir opposite the strap duct, the weir forms a barrier in the height direction between the strap duct and the strap cavity; and
a cover disposed on the mold section having:
a baseplate extending in a longitudinal direction perpendicular to the height direction and having a base protrusion protruding beyond the baseplate in a width direction perpendicular to the longitudinal direction and the height direction;
a top plate extending in the longitudinal direction and fastened to the baseplate, the top plate having a top protrusion protruding beyond the top plate in the width direction; and
a strap tab disposed between the baseplate and the top plate, the strap tab held between the base protrusion and the top protrusion in a height direction perpendicular to the longitudinal direction and the width direction and movable along the base protrusion in the width direction.

23. The mold system of claim 22, wherein the baseplate and the top plate are positioned in the feed trough and the base protrusion, the top protrusion, and the strap tab extend into the strap duct.

24. The mold system of claim 23, wherein the baseplate has a securing recess disposed at each of a first end of the baseplate and a second end of the baseplate opposite the first end in the longitudinal direction and the feed trough has a cover securing member disposed at each of a pair of opposite ends of the feed trough in the longitudinal direction, the cover securing member engaging the securing recess to secure the baseplate in the feed trough.

25. The mold system of claim 23, wherein the strap tab is movable along the base protrusion into a position in which the strap tab overlaps the strap duct in the height direction.

26. The mold system of claim 25, wherein the strap tab has a weir tip protruding from an end of the strap tab in the width direction, the weir tip is disposed approximately centrally on the end of the strap tab and is smaller than the strap tab in the longitudinal direction, the weir tip overlaps the weir opening in the height direction.

27. The mold system of claim 25, wherein a length of the strap tab in the longitudinal direction is approximately equal to a length of the strap duct in the longitudinal direction.

28. The mold system of claim 26, wherein the molten lead moves from the feed trough along a strap path under the strap tab and through the weir opening into the strap cavity.

29. The mold system of claim 25, wherein the baseplate has a recessed base portion smaller than the baseplate in the width direction and the top plate has a recessed top portion smaller than the top plate in the width direction, and the cover has a terminal tab disposed between the baseplate and the top plate, the terminal tab held between the recessed base portion and the recessed top portion in the height direction and movable along the recessed base portion in the width direction.

30. The mold system of claim 29, wherein the mold section has a terminal mold having a terminal channel extending from the feed trough and a terminal well disposed at an end of the terminal channel opposite the feed trough.

31. The mold system of claim 30, wherein the terminal tab is movable along the recessed base portion into a position in which the terminal tab overlaps the terminal channel in the height direction.

32. The mold system of claim 31, wherein the molten lead moves from the feed trough along a terminal path between the terminal tab and the terminal channel and into the terminal cavity.
